(19) United States
(12) Patent Application Publication
(10) Pub. No.: US 2010/0139477 A1
(43) Pub. Date: Jun. 10, 2010

(54) PISTON RATCHET ENGINE

(76) Inventor: Tommey Reed, Jensen Beach, FL (US)

Correspondence Address: The Intellect Law Group, 901 SW Martin Downs Blvd., Suite 321, Palm City, FL, 34990, US

(21) Appl. No.: 12/329,519

(22) Filed: Dec. 5, 2008

(51) Int. Cl. F01B 1/08; F02B 75/32

(52) U.S. Cl. 92/73; 123/197.1

(57) ABSTRACT

An engine design incorporating at least one piston synchronized via a ratchet or sprag freewheel mechanism.

### FIELD OF THE INVENTION

This invention relates to an engine design incorporating at least one piston and a ratchet mechanism.

### SUMMARY OF THE INVENTION

An object of the present invention is to provide an engine design which maximizes power output at all stages of piston deployment.

A further object of the present invention is to provide an engine mechanism which is simple in design and construction while remaining energy efficient.

The present invention utilizes ratchet mechanism or a bearing incorporating a unidirectional clutch (one way clutch bearing or sprag freewheel) which facilitates load bearing rotation of a gear about a central axis in a single direction and free rotation in the opposite direction. The present invention further incorporates a rack and pinion relationship between the pushrod housing (rack) and gears (pinion) to convert the linear motion of the pushrod housing into the rotational motion of the gears.

Other objects and advantages of the invention will be apparent from the following description, the accompanying drawings and the appended claims.

### BRIEF DESCRIPTION OF THE DRAWINGS

FIG. 1A depicts a side view of an embodiment of the present invention;

FIG. 1B depicts an alternate side view of the flywheel and crankrod in relation to the push rod housing.

FIG. 1C depicts an angled view of an embodiment of the present invention.

FIG. 2A depicts an exploded view of the gear and output shaft mechanism.

FIG. 2B depicts the push rod housing with teeth.

FIG. 2C depicts an alternate view of the push rod housing with teeth.

FIG. 2D depicts the flywheel and crankrod assembly.

FIG. 3A depicts an exploded view of an embodiment of the present invention.

FIG. 4A depicts an alternate view of the invention showing a piston assembled in relation to the push rod housing and gear assembly.

FIG. 4B depicts an alternate view of the invention showing two pistons assembled in relation to the push rod housing and gear assembly.

FIG. 4C depicts a an alternate view of the invention as depicted in FIG. 4B and further including the flywheel assembly assembled in relation to the push rod housing and gear assembly.

FIG. 5A depicts one possible embodiment of the housing for the proposed mechanism utilizing a 2 piston design.

FIG. 5B depicts an alternative embodiment of the invention incorporating a belt drive substitute for the push rod housing.

### DETAILED DESCRIPTION OF THE INVENTION

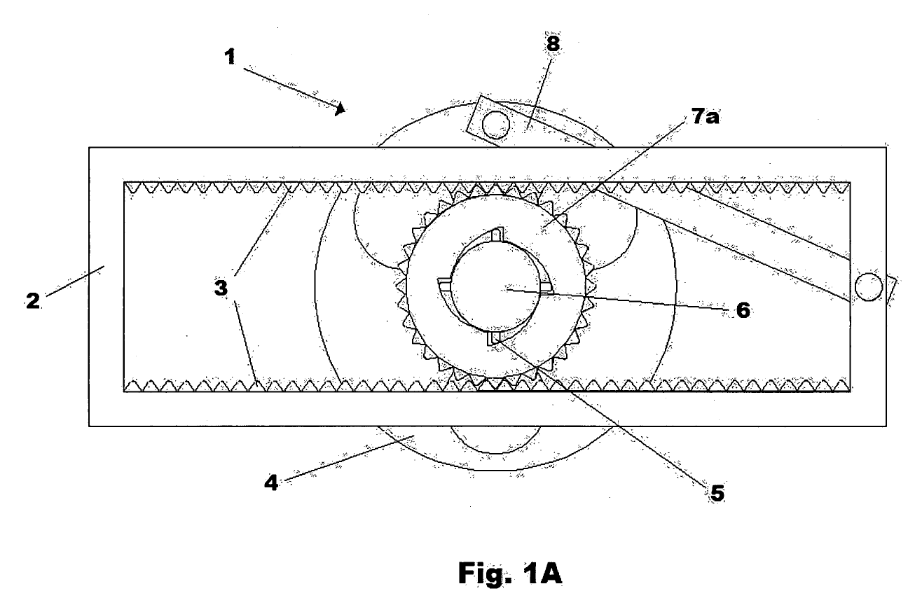

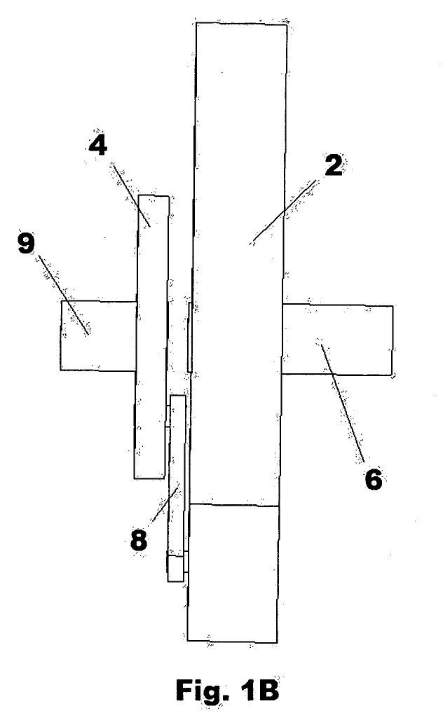

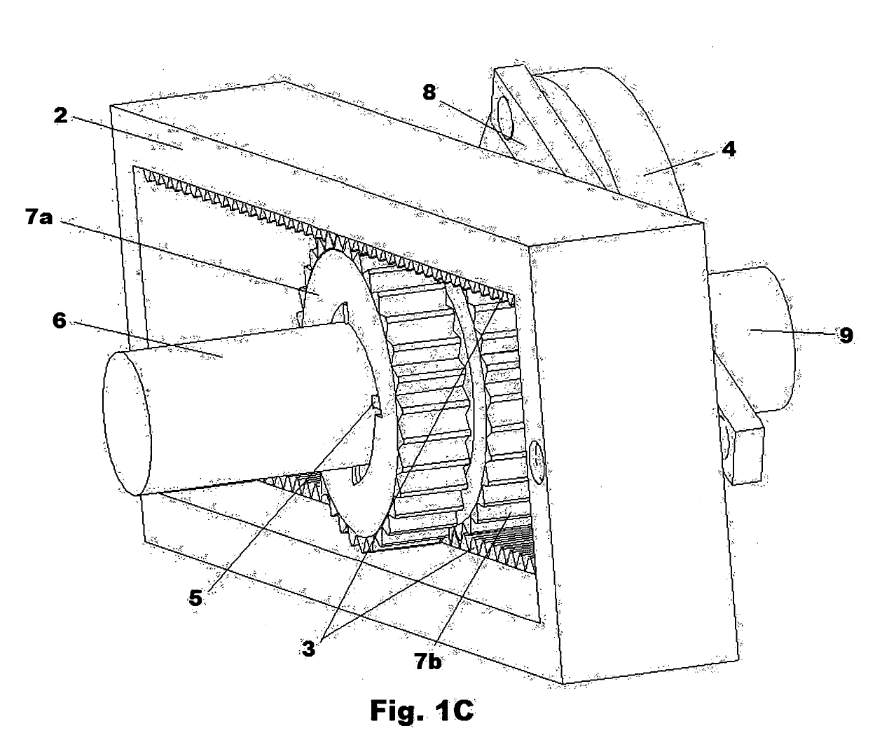

FIG. 1A depicts a side view of an embodiment of the invention showing the ratchet mechanism. The dual piston ratchet engine (1) utilizes a push rod housing (2) having teeth (3) which drive a first gear (7a). The gear is designed to resist torque in one direction only (clockwise or counter-clockwise), known as the resistive phase, and to be free wheeling about an inner bearing when rotated in the other direction, known as the free rotation phase. When the gear is rotated in the resistive phase, the gear drives an output shaft (6) attached to and in turn driving a flywheel (4). A crank rod (8) holds the flywheel in static relation to the push rod housing. A second gear (7b) (not shown in FIG. 1A) is aligned with the first gear and is designed to act in the resistive phase when said first gear is in a free rotation phase. Accordingly, during each gear's resistive phase, it will provide torque to the output shaft when the push rod housing is propelled by a push rod in response to a force. Said force may be as a consequence of the explosion of an air-fuel mixture, as is well known in the art, or by the force of any gas or liquid imparted upon a piston connected to the push rod housing.

FIG. 1B depicts an alternate side view of the flywheel (4) and crankrod (8) in relation to the push rod housing (2). The Crankrod (8) being attached to the flywheel (4) prevents the pushrod housing (2) from overtravel which could physically damage the pushrod housing, gears, output shaft or other connected mechanisms. While the present invention is designed to primarily transfer rotational power to the output shaft (6), the flywheel (4) also imparts a rotational force to a rear shaft (9).

FIG. 1C depicts an angled view of an embodiment of the present invention showing the first gear (7a) and second gear (7b) in physical relation within the push rod housing. Each gear is driven and rotated by the push rod housing (2) teeth (3) as the push rod housing is propelled via pistons (not shown in FIG. 1C) located at opposite ends of the housing (2).

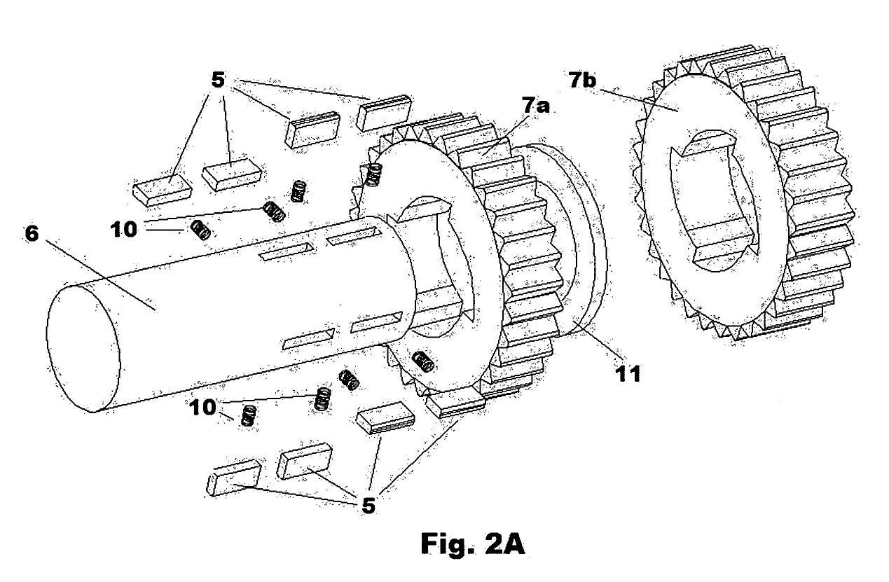

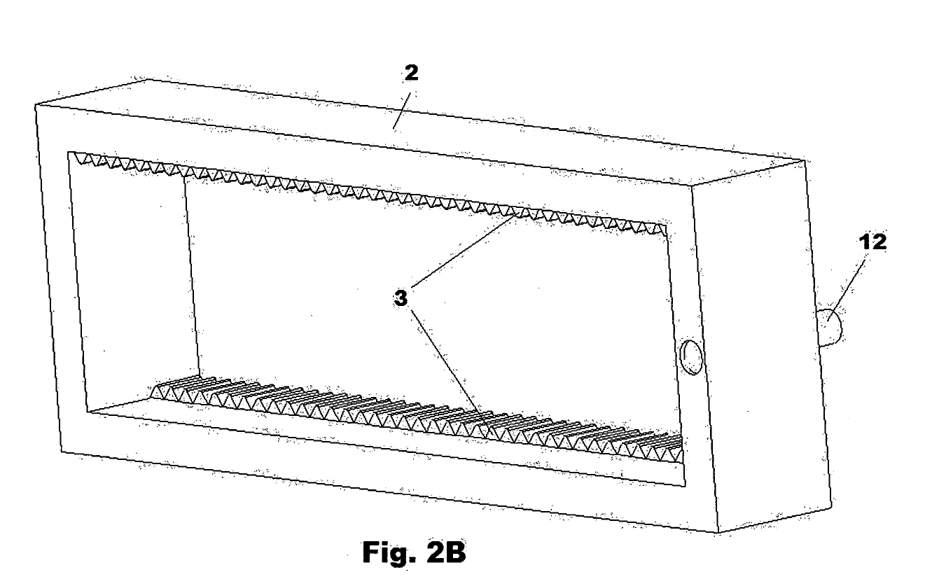

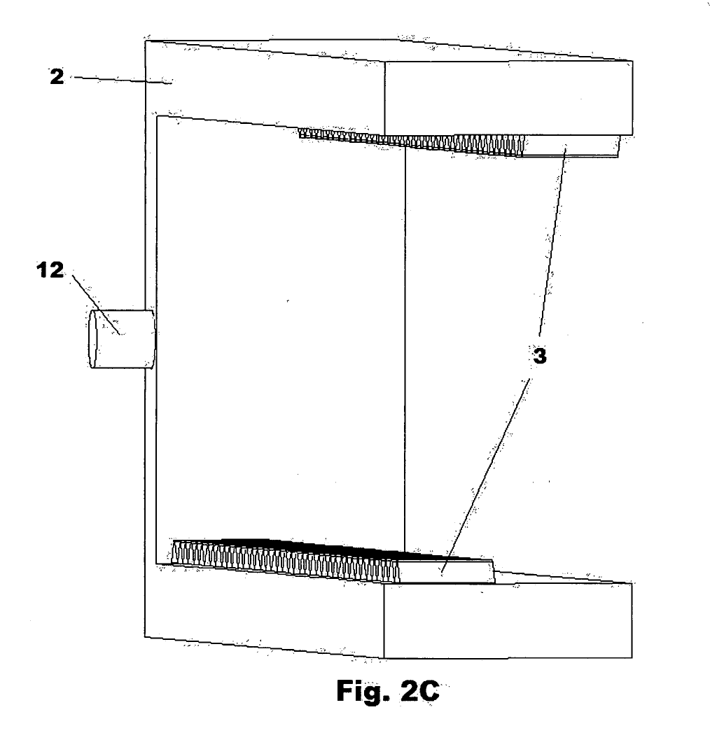

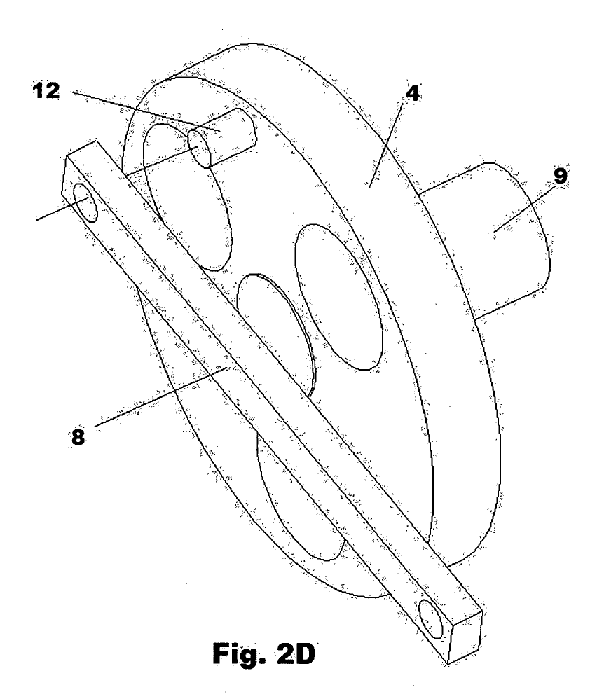

FIG. 2A depicts an exploded view of the gears (7a and 7b) and output shaft (6) mechanism. The first gear and second gear may incorporate spring (10) biased dogs or pins (5) to enable resistive and free rotation about the output shaft (6). A washer (11) or other equivalent mechanism may be utilized to reduce friction between said first gear (7a) and second gear (7b) during rotation.

FIG. 2B depicts the push rod housing (2) with teeth (3). The teeth (3) may be aligned offset within the pushrod housing such that the teeth incorporated into the top of the pushrod housing contact first gear and the teeth incorporated into the bottom of the pushrod housing contact the second gear. The connecting pin (12) secures the crank rod (8) to the pushrod housing (2).

FIG. 2C depicts an alternate view of the push rod housing (2) with teeth (3). This embodiment also reflects an offset alignment of the teeth (3) on the upper and lower portions of the pushrod housing (2).

FIG. 2D depicts the flywheel (4) and crank rod (8) assembly. A connecting pin (12) secures the crank rod to the flywheel.

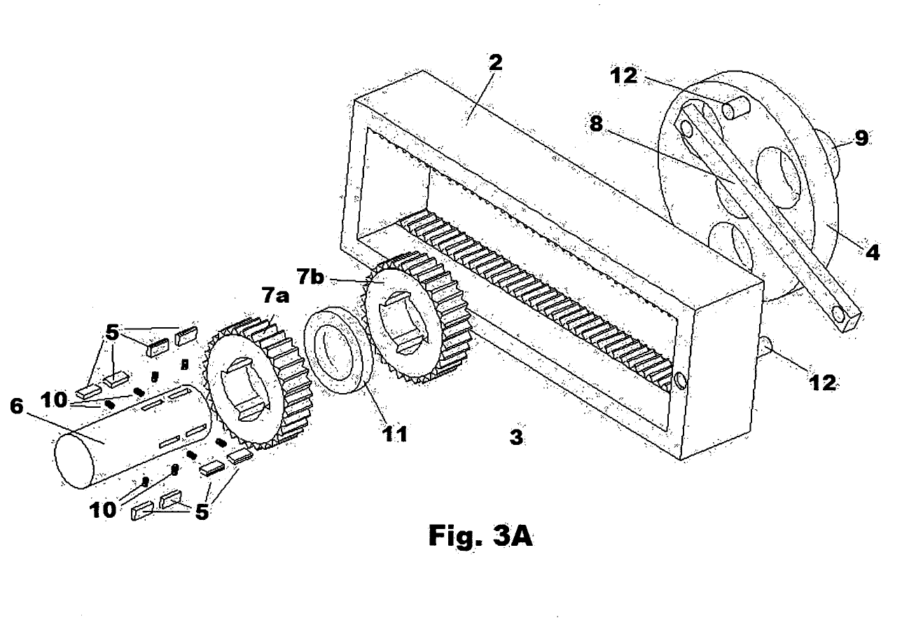

FIG. 3A depicts an exploded view of an embodiment of the present invention.

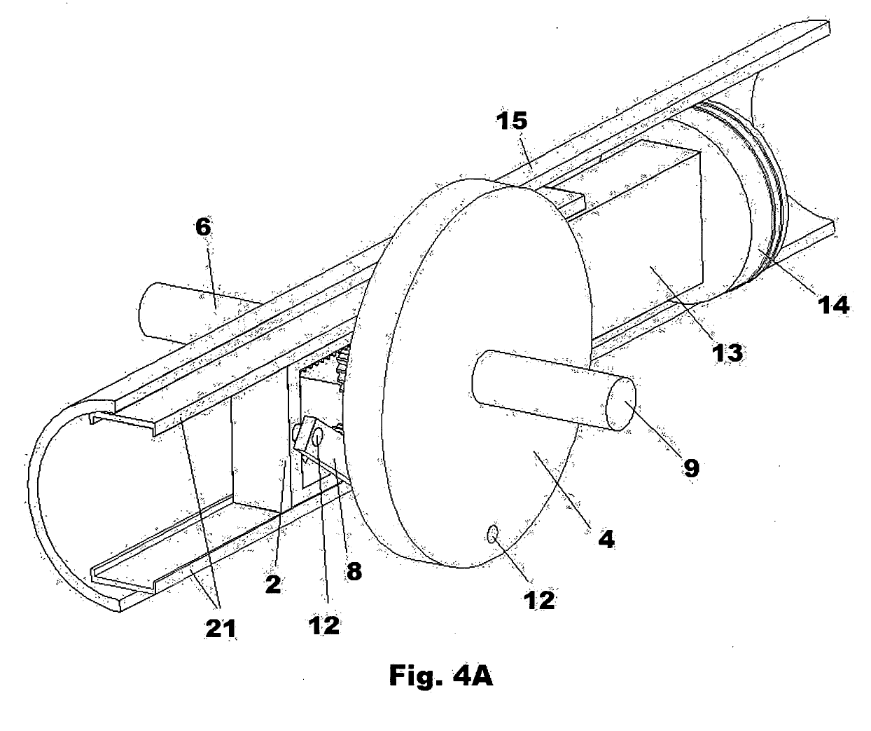

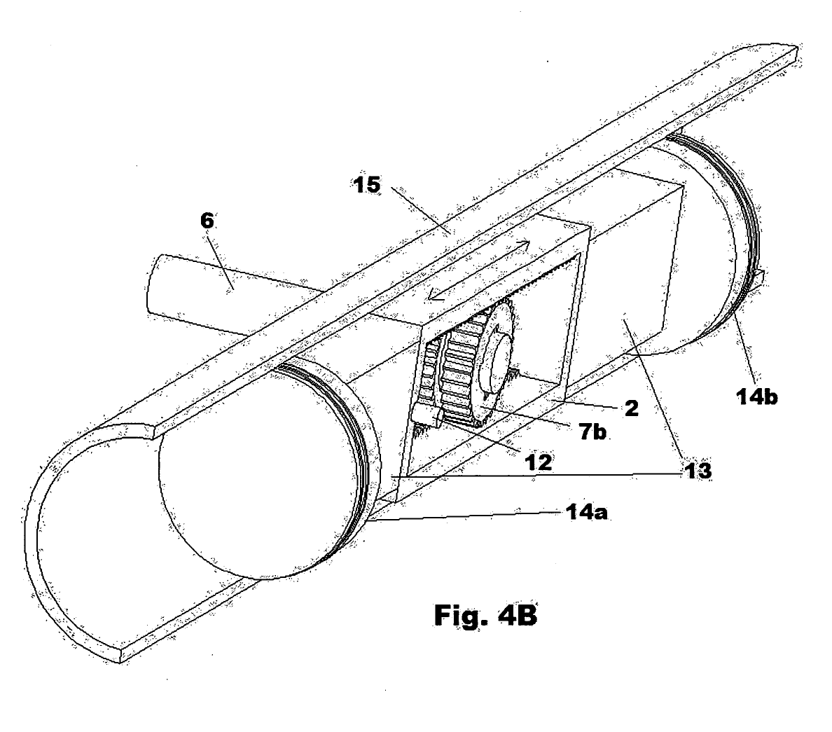

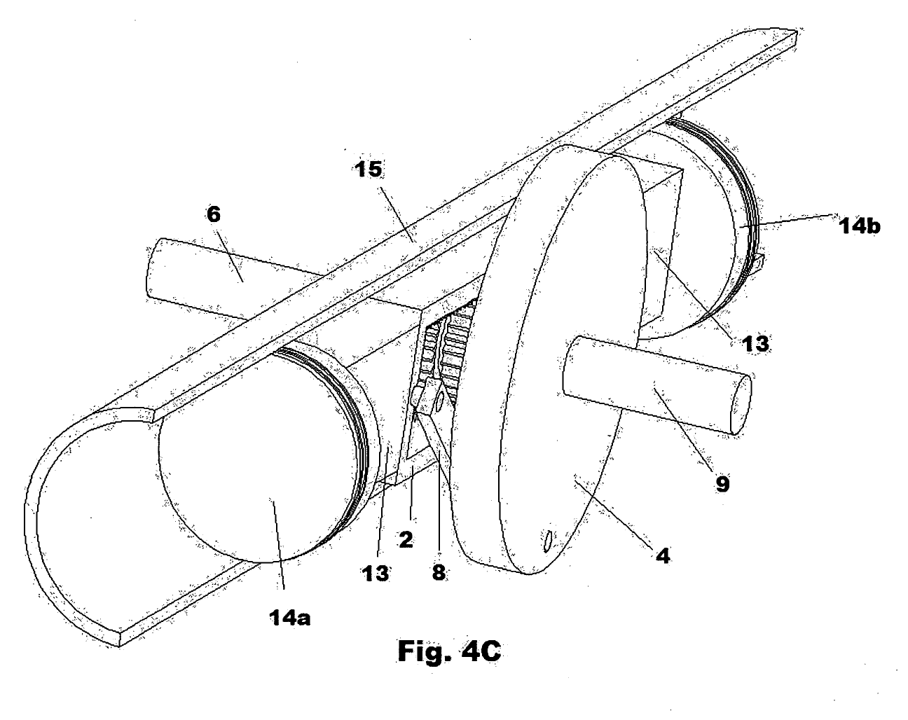

FIG. 4A depicts an alternate view of the invention showing a first piston (14) assembled in relation to the push rod housing (2) and gear assembly within a cutaway view of a piston housing (15). In this figure the piston (14) is connected to the pushrod housing by pushrods (13) which may be any mechanism or device sufficient to secure a piston (14) to an opposite end of the push rod housing (2). In yet another embodiment, the pushrods (13) depicted in this figure may be eliminated and the pistons secured directly to the pushrod housing. Alternatively, the push rod housing (2) may be designed to incorporate surfaces at opposite ends of the housing which function as piston surfaces, thereby completely eliminating separate pistons and pushrods. The pushrod housing may travel within top and bottom brackets (21) within the housing (15). Also shown is the flywheel assembly assembled in relation to the push rod housing (2) and gear assembly. The flywheel assembly acts to transfer torque from the pushrod housing (2) to the rear shaft (9). The flywheel assembly also counteracts torque created from transfer of energy from the pushrod housing to the output shaft and rear shaft.

FIG. 4B depicts a two piston alternate embodiment of the invention as depicted in FIG. 4A and further includes a first gear (7a) and second gear (7b) shown within the push rod housing (2). When a force is applied against the face of a first piston (14a), the force is transferred to the pushrod housing (2) and via the teeth (3) to a first gear (7a) in resistive phase. The first gear (7a) rotates in response to the force, thereby transferring the force to the output shaft (6). While first gear (7a) is rotating in resistive phase, second gear (7b) is rotated via the push rod housing and teeth in free rotation phase, imparting no force upon the output shaft. A second force, timed to coincide with full travel of the gears within the confines of the pushrod housing, is then imparted upon a second piston (14b), which force is transferred to the pushrod housing (2) and via the teeth (3) to a second gear (7b) which is now in resistive phase while said first gear (7a) is in free rotation phase.

FIG. 4C depicts a depicts a an alternate view of the invention as depicted in FIG. 4B further depicting the flywheel, connecting rod and rear shaft assembly in relation to the pushrod housing assembly.

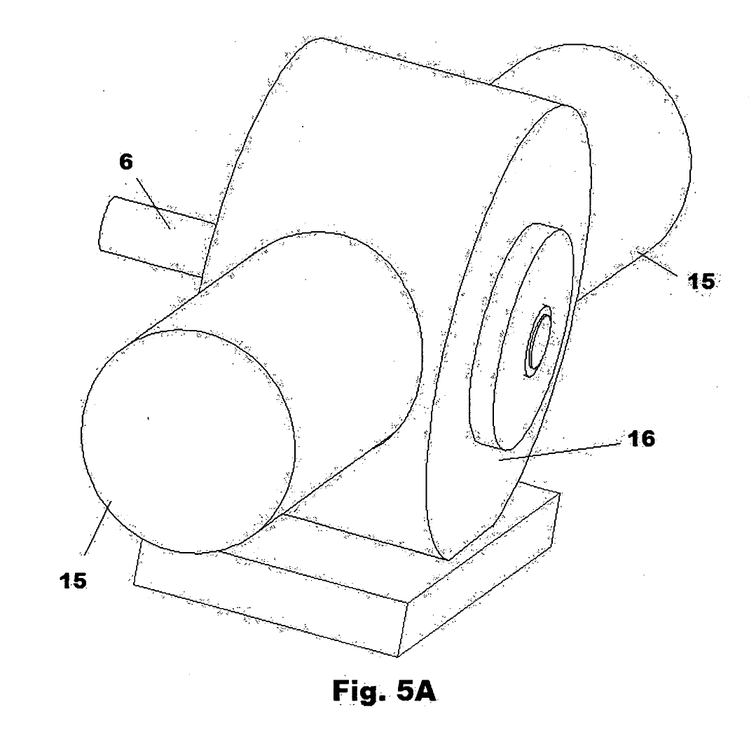

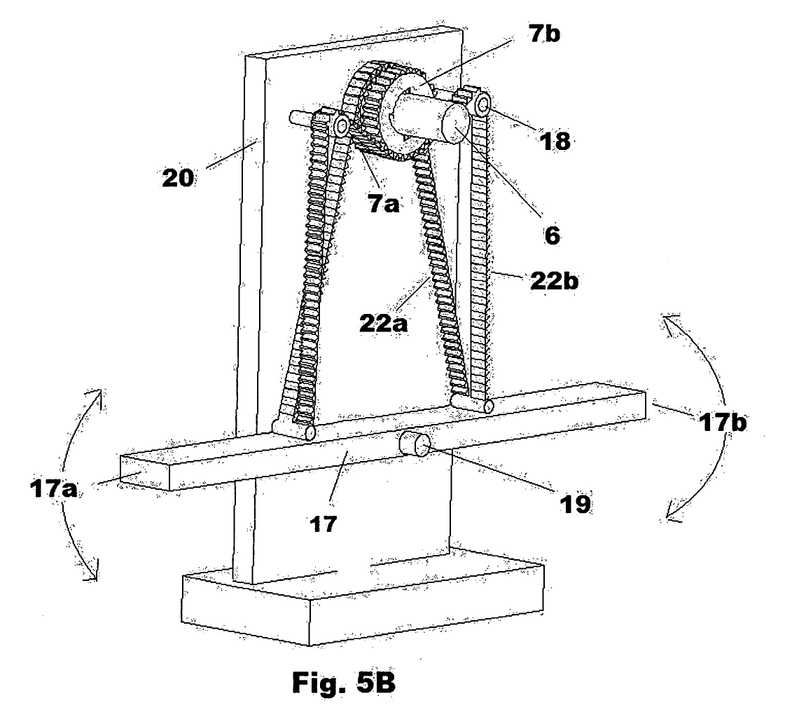

FIG. 5A depicts one possible embodiment of the piston housing (15) and engine housing (16) for the proposed mechanism utilizing a 2 piston design.

FIG. 5B depicts an alternative possible embodiment of the invention, substituting a belt for the pushrod housing and gears. In this embodiment, a rocker (17) having a first end (17a) and a second end (17b), is rotated about a pin (19) in response to a force such as an air-fuel mixture explosion, release of gas or liquid under pressure or with force or any other energy substitute known in the arts upon said rocker first end. Movement of the rocker (17) drives a first belt (22a) which rotates a first gear (7a) in resistive phase, transferring such force to the output shaft (6). While first gear (7a) is rotating in resistive phase, second gear (7b) is rotated via a second belt (22b) in free rotation phase, imparting no force upon the output shaft. A second force, timed to coincide with full travel of the rocker, is then imparted upon the rocker second end (17b), which force drives the second belt (22b) transferring the force to a second gear (7b) which is now in resistive phase while said first gear (7a) is in free rotation phase, and via said second gear to the output shaft (6).

Although preferred embodiments of the system and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. An apparatus comprising:
A pushrod housing substantially rectangular in shape having a first and second ends, a top and a bottom, said pushrod housing containing teeth for driving a gear, said teeth located along the inner surfaces of said pushrod housing's top and bottom;
A first gear located within said pushrod housing and aligned such that said first gear may travel along the pushrod housing axis substantially from said first end to said second end;
A second gear located within said pushrod housing and aligned such that said second gear may travel along the pushrod housing axis substantially from said first end to said second end;
Said first gear and said second gear having a output shaft aligned traversely through the gear centers;
Each gear constructed such that rotation of the gear in a first direction along the pushrod housing axis substantially from said first end to said second end imparts a force upon the output shaft and rotation of the gear in a second direction along the pushrod housing axis substantially from said first end to said second end does not impart a force upon the output shaft;
Said first and second gear installed within said pushrod housing such that when one of such gears imparts a force, the second of such gears does not impart a force; and
a flywheel mounted to said output shaft, said flywheel connected to said pushrod housing via a crank rod.

2. The apparatus of claim 1 further comprising said pushrod housing having a piston secured to an outside end surface.

3. The apparatus of claim 1 further comprising said pushrod housing having a first piston secured to an outside surface first end and a second piston secured to an outside surface second end.

4. The apparatus of claim 1 wherein said output shaft is secured to said first gear and said second gear via dogs.

5. The apparatus of claim 4 wherein said dogs are spring-biased.

6. The apparatus of claim 1 wherein a washer is installed on said output shaft between said first gear and said second gear.

7. The apparatus of claim 2 further comprising a housing to contain said piston and pushrod housing.

8. The apparatus of claim 3 further comprising a housing to contain said pistons and pushrod housing.

9. The apparatus of claim 1 wherein the gears are installed such that the force imparted by each of the gears on the output shaft rotates the shaft in the same direction.

10. The apparatus of claim 1 wherein the first gear and second gear incorporate a ratchet mechanism to enable the driving force upon the output shaft.

11. The apparatus of claim 1 wherein the first gear and second gear incorporate a unidirectional clutch to enable the driving force upon the output shaft.

12. The apparatus of claim 1 wherein the first gear and second gear incorporate a sprag freewheel to enable the driving force upon the output shaft.

13. An apparatus comprising:
A rocker having a first and second ends, said rocker connected to a first belt and second belt;
A first gear and a second gear having an output shaft aligned traversely through the gear centers;
Said first gear and said second gear having gear teeth aligned to accept a belt from said rocker;
Each gear constructed such that rotation of the gear in a first direction imparts a force upon the output shaft and rotation of the gear in a second direction does not impart a force upon the output shaft;
Said first and second gear installed such that when one of such gears imparts a force, the second of such gears does not impart a force;
Such that when said rocker drives a first belt in response to a force placed upon the rocker first end;
Said belt rotates a first gear, transferring said force to said output shaft, rotating said output shaft in a first direction; and
Such that when said rocker drives a second belt in response to a force placed upon the rocker second end;
Said belt rotates a second gear, transferring said force to said output shaft, rotating said output shaft in a first direction.
